(19) United States
(12) Patent Application Publication
(10) Pub. No.: US 2009/0310352 A1
(43) Pub. Date: Dec. 17, 2009

(54) LED LAMP

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/422,296

(22) Filed: Apr. 13, 2009

(30) Foreign Application Priority Data
Jun. 13, 2008 (CN) 200810067736.5

(51) Int. Cl. F21V 1/00

(52) U.S. Cl. 362/235

(57) ABSTRACT

An LED lamp includes a concave lamp enclosure, a base, a plurality of LEDs and a lens. The base is received in the lamp enclosure and located at a bottom of the lamp enclosure. The base has a curved, concave top surface. The LEDs are distributed on the top surface of the base. The lens is received in the lamp enclosure and located over the LEDs. The lens has a curved, convex light input surface. The light input surface faces and spaces from the top surface of the base to define a space between the light input surface of the lens and the top surface of the base.

### BACKGROUND

1. Technical Field

The present invention generally relates to a light emitting diode (LED) lamp, and more particularly to an LED lamp which can provide soft and even light.

2. Description of Related Art

As an energy-efficient light, an LED lamp has a trend of substituting for the fluorescent lamp for a lighting purpose. In order to increase the overall lighting brightness, a plurality of LEDs are often incorporated into a lamp. However, light emitted by all of the LEDs are reflected to a center of the LED lamp; therefore, the LED lamp is substantially in the form of a point light source. Thus, uncomfortable glare may be caused by the LED light sources.

What is needed, therefore, is an LED lamp which can provide soft and even light.

### BRIEF DESCRIPTION OF THE DRAWINGS

FIG. 1 is a cross-sectional view of an LED lamp in accordance with a first embodiment.

FIG. 2 is a cross-sectional view of an LED lamp in accordance with a second embodiment.

### DETAILED DESCRIPTION

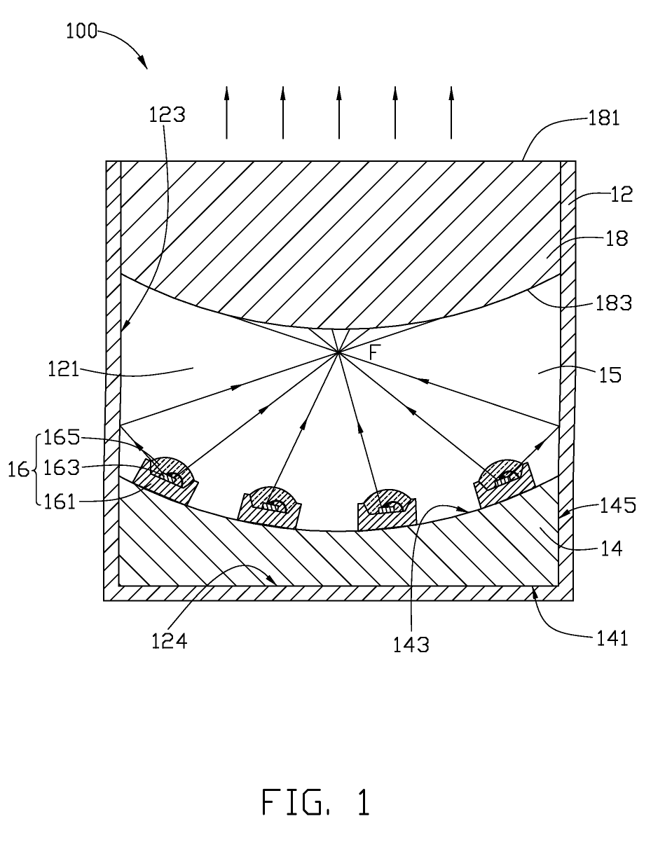

Referring to FIG. 1, an LED lamp 100 in accordance with a first embodiment is illustrated. The LED lamp 100 includes a hollow lamp enclosure 12, a base 14, a plurality of LEDs 16 and a lens 18. The base 14, the LEDs 16 and the lens 18 are received in the lamp enclosure 12.

The lamp enclosure 12 has a cylindrical shape and defines a cavity 121 therein. A top end of the lamp enclosure 12 is open, whereas a bottom end of the lamp enclosure 12 is closed. The lamp enclosure 12 includes an inside, lateral wall 123 and an inside, bottom wall 124. The lateral wall 123 and the bottom wall 124 cooperatively define the cavity 121 therebetween.

The base 14 is received in the cavity 121 and located on the bottom wall 124 of the lamp enclosure 12. The base 14 has an approximately column shape. The base 14 has a flat bottom surface 141, a curved top surface 143 and a cylindrical, lateral surface 145. The bottom surface 141 is attached to the bottom wall 124 of the lamp enclosure 12. The lateral surface 145 is attached to a bottom portion of the lateral wall 123 of the lamp enclosure 12. The top surface 143 is concave as being a part of a spherical surface. The top surface 143 is depressed downwardly from a periphery to a center thereof so that a vertical length of the base 14 decreases gradually from the periphery to the center of the top surface 143.

The LEDs 16 are evenly arranged on the top surface 143. The top surface 143 has a focal point F as the central point of the spherical surface in which the top surface 143 is located. The focal point F is above the top surface 143 so that a portion of light emitted by the LEDs 16 certainly passes through the focal point F.

Each LED 16 includes a cup-shaped substrate 161, a chip 163 and an encapsulation 165. The encapsulation 165 is made of a light penetrable material, such as acryl, silicone or epoxy resin. The encapsulation 165 encapsulates the chip 14 in the substrate 161. The substrate 161 is attached to the top surface 143.

The lens 18 is made of a light penetrable material, such as acryl, silicone, epoxy resin or glass. The lens 18 is secured at the top end of the lamp enclosure 12 and located over the LEDs 16. The lens 18 has an approximately column shape. A lateral surface of the lens 18 is attached to a top portion of the lateral wall 123 of the lamp enclosure 12. The lens 18 has a flat, light output surface 181 and a curved, light input surface 183. The light output surface 181 is located at the top end of the lens 18 and faces an outside over the LED lamp 100. The light input surface 183 is located at the bottom end of the lens 18 and opposite to the light output surface 181, and faces the LEDs 16.

The light input surface 183 is convex as being a part of a spherical surface. The light input surface 183 protrudes downwardly from a periphery to a center thereof so that a vertical length of the lens 18 increases gradually from the periphery to the center of the light input surface 183. The light input surface 183 of the lens 18 faces the top surface 143 of the base 14. A space 15 is formed between the lens 18 and the base 14 in the lamp enclosure 12. The focal point F of the top surface 143 is below the light input surface 183. A focus of the lens 18 is coincident with the focal point F of the top surface 143.

For improving reflectivity of the lateral wall 123 of the lamp enclosure 12, a high reflective material is spread on the lateral wall 123, especially the part of the lateral wall 123 located above the LEDs 16. The reflective material is selected from aluminum or sliver and formed on the lateral wall 123 by spraying, plating or sputtering.

In operation, a portion of light emitted by the LEDs 16 is firstly directed to and reflected by the lateral wall 123 of the lamp enclosure 12, and then directed to different parts of the light input surface 183 of the lens 18 from different directions. Another portion of light emitted by the LEDs 16 is directly transmitted to the light input surface 183 of the lens 18. The light then enters the lens 18 from different directions through the light input surface 183. A portion of light in the lens 18 is directly emitted out of the lens 18 through the light output surface 181. Another portion of light in the lens 18 is firstly directed to and reflected by the lateral wall 123 for at least one time, then directed to every parts of the light output surface 181, and at last emitted out of the lens 18 along different directions.

In a word, the light emitted by the LEDs 16 enters the lens 18 along different directions and then emits out of the lens 18 from different parts of the light output surface 181 along different directions, so that the light is evenly distributed at the whole area of the light output surface 181. Accordingly, the light provided by the light output surface 184 becomes even and soft so as to reduce uncomfortable glare.

Because the focal point F of the top surface 143 coincides with the focus of the lens 18, the light from the LEDs 16 passing through the focal point F is evenly and widely directed to the light input surface 183, and then emitted out of the light output surface 184 along parallel directions. Thus, the light provided by the light output surface 184 becomes more even and soft. Alternatively, the focal point F may be closed to the focus of the lens 18, not necessarily coinciding with each other.

Alternatively, the lamp enclosure 12 can be made of aluminum or sliver and the lateral wall 123 can be made to have a smooth surface so as to omit the high reflective material spread on the lateral wall 123. Furthermore, the lateral surface of the lens 18 abutting the lateral wall 123 can be made to have a smooth surface so as to form a reflective surface for light.

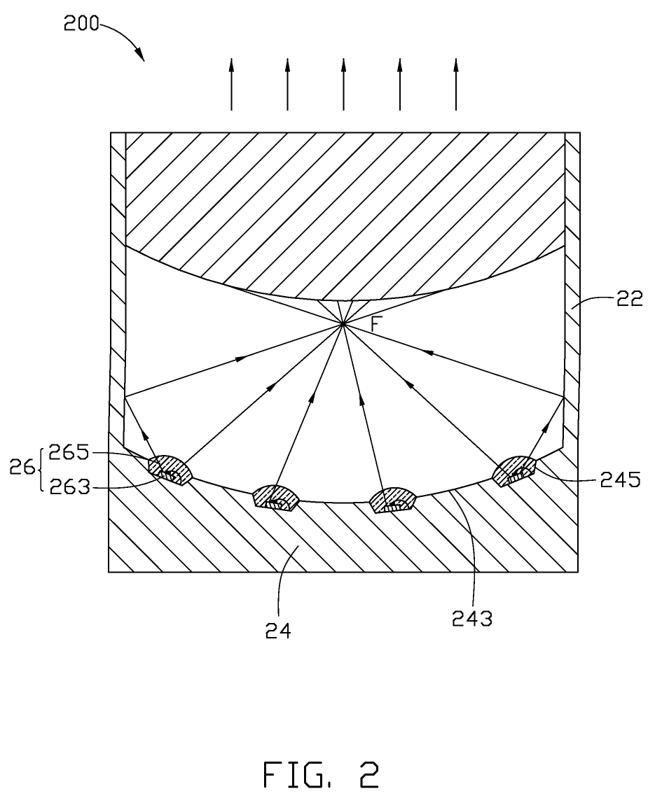

Referring to FIG. 2, an LED lamp 200 according to a second embodiment is shown. The LED lamp 200 is similar to the LED lamp 100, only differing from the LED lamp 100 in the structures of the lamp enclosure 22, the base 24 and the LEDs 26. The base 24 is integrally formed with the lamp enclosure 22. In forming the LEDs 26, at first, a plurality of recesses 245 is defined in a top surface 243 of the base 24. Then a plurality of LED chips 263 is placed in the recesses 245 respectively. At last, a light penetrable material, such as acryl, silicone or epoxy resin, is filled into the recesses 245 to encapsulate the chips 263 and form the encapsulations 265. Thus, the LEDs 26 are firmly secured to the base 24.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp comprises:
a base including a concave top surface;
a plurality of LEDs distributed on the top surface of the base; and
a lens located over the LEDs, the lens including a convex light input surface, the light input surface facing and spaced from the top surface of the base to define a space between the light input surface of the lens and the top surface of the base.

2. The LED lamp of claim 1, wherein the top surface is a part of a spherical surface, the top surface has a focal point as a central point of the spherical surface in which the top surface is located, a focus of the lens is coincident with the focal point of the top surface.

3. The LED lamp of claim 1, wherein a plurality of recesses are defined in the top surface of the base, a plurality of LED chips are received in the recesses respectively, and a light penetrable material is filled into each of the recesses and encapsulates the chips, the LED chips and the light penetrable material constituting the LEDs.

4. The LED lamp of claim 1, wherein the LEDs are evenly distributed on the top surface of the base.

5. The LED lamp of claim 1, further comprising a hollow lamp enclosure receiving the base, the LEDs and the lens therein, a bottom end of the lamp enclosure is closed, and a top end of the lamp enclosure is opened and receives the lens therein.

6. The LED lamp of claim 5, wherein the lamp enclosure includes a bottom wall and a lateral wall extending upwardly from a periphery of the bottom wall, the base is separately formed and then assembled to the lamp enclosure, a bottom surface of the base is attached to the bottom wall of the lamp enclosure.

7. The LED lamp of claim 5, wherein the lamp enclosure includes a bottom wall and a lateral wall extending integrally upwardly from a periphery of the bottom wall, the bottom wall forms the base of the LED lamp.

8. The LED lamp of claim 6, wherein the base has a column shape, and a lateral surface of the base is attached to a bottom portion of the lateral wall of the lamp enclosure.

9. The LED lamp of claim 8, wherein the lens has a column shape, and a lateral surface of the lens is attached to a top portion of the lateral wall of the lamp enclosure.

10. The LED lamp of claim 1, wherein the light input surface is located at a bottom end of the lens, and an output surface is formed at a top end of the lens and faces an outside of the LED lamp.

11. The LED lamp of claim 1, wherein the top surface of the base is depressed downwardly from a periphery to a center thereof so that a vertical length of the base decreases gradually from the periphery to the center of the top surface.

12. The LED lamp of claim 1, wherein the light input surface protrudes downwardly from a periphery to a center thereof so that a vertical length of the lens increases gradually from the periphery to the center of the light input surface.
